(19) United States
(12) Patent Application Publication
(10) Pub. No.: US 2026/0172317 A1
(43) Pub. Date: Jun. 18, 2026

(54) Method for Application of GNN-Based Network Digital Twin to BGP Route Selection, Fault Localization, Topology Planning, and Failure Analysis

(71) Applicant: Ciena Corporation, Hanover, MD (US)

(72) Inventors: Christopher Barber, Ottawa (CA); Mohamed Zalat, Ottawa (CA); Babak Esfandiari, Ottawa (CA); Thomas Kunz, Ottawa (CA)

(73) Assignee: Ciena Corporation, Hanover, MD (US)

(21) Appl. No.: 19/056,919

(22) Filed: Feb. 19, 2025

Related U.S. Application Data
(60) Provisional application No. 63/733,489, filed on Dec. 13, 2024.

(51) Int. Cl. H04L 41/0654; H04L 9/40; H04L 43/026; H04L 43/0829; H04L 43/0852; H04L 43/50

(52) U.S. Cl. CPC H04L 41/0654; H04L 43/026; H04L 43/0829; H04L 43/0852; H04L 43/50; H04L 63/0876

(57) ABSTRACT

Systems and methods for network management are disclosed herein, including collecting network information including at least a topology of the network, traffic flow characteristics, and network performance data; constructing a digital twin of the network based on the collected information, wherein the digital twin includes nodes, links, and associated traffic flows; applying a machine learning model to the digital twin to predict QoS metrics for each traffic flow; and outputting the predicted QoS metrics for further analysis or network actions. The digital twin can be used for various use cases, including, e.g., localizing faults, optimizing QoS metrics over potential BGP routes, network planning to optimize network topologies, what-if failure scenarios, and the like.

### CROSS-REFERENCE TO RELATED APPLICATION(S)

The present disclosure claims priority to U.S. Provisional Patent Application No. 63/733,489, filed Dec. 13, 2024, the contents of which are incorporated by reference in their entirety.

### FIELD OF THE DISCLOSURE

The present disclosure relates generally to networking and computing. More particularly, the present disclosure relates to systems and methods for Network Digital Twin Architecture implemented into network action and optimization.

### BACKGROUND OF THE DISCLOSURE

Root Cause Analysis (RCA) in communication networks is essential for identifying and addressing the components causing network malfunctions. However, as networks grow in size and complexity, detecting “gray failures”—subtle or silent faults that evade traditional monitoring tools—becomes increasingly challenging. For instance, a router might experience a firmware issue that silently drops packets to or from a specific port while falsely reporting normal operations to monitoring tools like SNMP. Similarly, misconfigurations, such as incorrect traffic shaping policies, can degrade performance on certain links. These gray failures often require extensive manual debugging, which is time-consuming and error prone. Existing methods, such as deploying meters, pinging devices, or relying on mathematical approximations of network metrics, offer partial solutions but fail to comprehensively and efficiently localize faults. Such existing methods are slow and tedious due to being based on explicit simulations or manual inspection, limiting the number of scenarios that can be tested. This means that the solution found will often not be ideal, as the solution space cannot be fully explored.

The limitations of current approaches underscore the need for optimized methods to address gray faults. Traditional solutions are slow and tedious, relying on explicit simulations or manual inspections that significantly constrain the number of scenarios that can be tested. As a result, the solutions derived are often suboptimal, as the full solution space cannot be thoroughly explored. Furthermore, many of these methods focus narrowly on link utilization, neglecting critical Quality of Service (QoS) metrics such as delay, packet loss, and jitter, which are vital for network performance. Operators are thus left to solve these issues through labor-intensive manual processes or simulation-based what-if scenario planning, neither of which scales effectively to meet the demands of modern networks. Optimized methods that can automate fault detection while considering a broader range of metrics are needed to ensure faster, more accurate fault resolution in evolving network environment.

### BRIEF SUMMARY OF THE DISCLOSURE

The present disclosure relates to systems and methods for exemplary embodiments of general architecture of a Network Digital Twin (NDT) and a methodology for adapting it to different network optimization problems by adjusting its optimizer component. One aspect of the present disclosure pertains to a Network Digital Twin (NDT), The NDT is an advanced architecture combining a Graph Neural Network (GNN)-based Machine Learning (ML) model with a local search algorithm to tackle various network optimization and management challenges. The GNN can predict Quality of Service (QoS) metrics, such as delay, loss, and jitter, while the local search algorithm iteratively explores solution spaces tailored to specific tasks. As such, the NDT can embody an adaptable framework which can address multiple network problems, including BGP route selection, network fault localization, topology planning, and what-if failure analysis. For BGP route selection, the NDT can optimize router choices to enhance QoS while meeting constraints like delay and utilization. In fault localization, the NDT can identify faulty devices or links by analyzing discrepancies between predicted and actual QoS metrics. For topology planning, the NDT can identify cost-effective network configurations that meet performance constraints for both new and existing networks. In what-if failure analysis, it simulates failures to pinpoint and prioritize critical nodes or links based on their impact on QoS. Importantly, the NDT can integrate ML with iterative optimization and can provide NDT with a scalable solution for network operators.

In one aspect, disclosed is a method for network management including creating a digital shadow of a network defining one or more of current network topologies, traffic flows, and delays and losses, computing via a machine learning model an expected delays and losses per flow, comparing one or more expected delays to a corresponding value in a real network to define one or more network condition, and performing an action responsive to the network condition.

In another aspect, disclosed is a non-transitory computer readable medium storing instructions that, when executed on a device, cause the steps of creating a digital shadow of a network defining one or more of current network topologies, traffic flows, and delays and losses, computing via a machine learning model an expected delays and losses per flow, comparing one or more expected delays to a corresponding value in a real network to define one or more faulty links, comparing one or more expected delays to a corresponding value in a real network to define one or more faulty flows, and localizing one or more faulty links.

### BRIEF DESCRIPTION OF THE DRAWINGS

The present disclosure is detailed through various drawings, where like components or steps are indicated by identical reference numbers for clarity and consistency.

FIG. 1 is a network diagram of a network of network elements interconnected by links.

FIG. 2 is a block diagram of an example network element (node) for use with the systems and methods described herein.

FIG. 3 is a block diagram of a controller which can form a controller for the network element, a PCE, an SDN controller, a management system, or the like.

FIG. 4 is a schematic of an example of an NDT shadow architecture in accordance with one aspect of the present disclosure.

FIG. 5 is a schematic of an alternative example of an NDT architecture in accordance with an alternative aspect of the present disclosure.

FIG. 6 is an alternative schematic of the example NDT architecture of FIG. 1 depicting exemplary settings for IGP weights.

FIG. 7 is a schematic depicting an example iterative algorithm in accordance with another aspect of the present disclosure.

FIG. 8 is a schematic depicting a failure analysis in accordance with one aspect of the present disclosure.

FIG. 9 is a table depicting an example approach of an application of the NDT architecture in accordance with another aspect of the present disclosure.

FIG. 10 is a flowchart depicting a method in accordance with the present disclosure.

FIG. 11 is a flowchart depicting another method in accordance with the present disclosure.

### DETAILED DESCRIPTION OF THE DISCLOSURE

Again, the present disclosure relates to systems and methods leveraging a Network Digital Twin (NDT) architecture for addressing complex network optimization and fault localization challenges. One aspect of this disclosure pertains to the application of the NDT for localizing gray faults in networks. This advanced architecture combines a Graph Neural Network (GNN)-based Machine Learning (ML) model with a heuristic search algorithm. The GNN can predict Quality of Service (QoS) metrics, such as delay, loss, and jitter, while the heuristic search algorithm identifies the smallest set of links or devices responsible for discrepancies between predicted and actual end-to-end (E2E) metrics. Unlike traditional methods that rely on pinging devices or measuring loss, the present application provides an approach which uses ground truth delay measurements from current network traffic flows and can compare them with predictions from a trained RouteNet-F model, which can assume accurate predictions under normal network operations. Using an Absolute Percentage Error (APE) threshold, the NDT differentiates between normal and disrupted flows to isolate the most probable sources of network faults.

The NDT's adaptable framework can be configured to address a range of network problems, including BGP route selection, topology planning, and what-if failure analysis. For BGP route selection, the NDT optimizes router configurations to enhance QoS while meeting constraints like delay and utilization. For topology planning, it can design network configurations that effectively meet performance requirements for both greenfield and existing deployments. In what-if failure analysis, it can simulate failure scenarios to identify and rank critical nodes or links based on their impact on network performance. By integrating ML models with iterative optimization and leveraging real-time network measurements, the NDT can provide a scalable solution for network operators to enhance performance, reliability, and fault resolution across diverse challenges.

The method can include a framework for dynamically optimizing and troubleshooting network performance using a GNN-based NDT. The method includes identifying faulty network components by comparing predicted and actual Quality of Service (QoS) metrics, such as delay, loss, and jitter, and applying triangulation techniques to localize issues. In some implementations, it supports topology planning by iterating through possible configurations to satisfy architectural constraints and selecting an optimal design. Failure analysis can also be performed by simulating the removal of individual nodes or links to evaluate their criticality to network operations. Furthermore, the method addresses BGP route optimization by analyzing multiple scenarios to enhance QoS metrics, and discrepancies between predicted and observed network performance can guide fault localization efforts. The system thus provides a comprehensive tool for network architects to design, maintain, and troubleshoot networks efficiently.

### Processing Circuitry and Non-Transitory Computer-Readable Mediums

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); Programmable Logic Device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Example Network

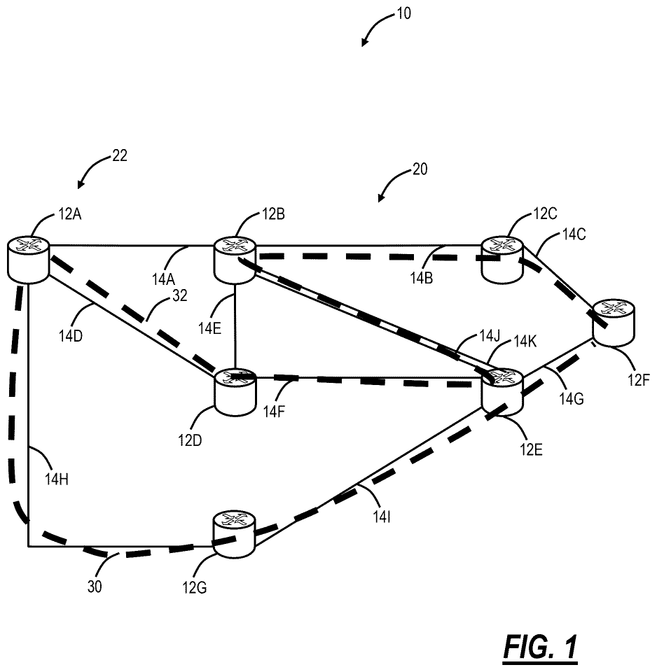

FIG. 1 is a network diagram of a network 10 of network elements 12 (labeled as network elements 12A-12G) interconnected by links 14 (labeled as links 14A-14I). The network elements 12 communicate with one another over the links 14 through Layer 0 (L0) such as optical wavelengths (Dense Wave Division Multiplexing (DWDM)), Layer 1 (L1) such as OTN, Layer 2 (L2) such as Ethernet, MPLS, etc., Layer 3 (L3) protocols, and/or combinations thereof. The network elements 12 can be network elements which include a plurality of ingress and egress ports forming the links 14. The network elements 12 can be switches, routers, cross-connects, etc. operating at one or more layers. An example network element 12 implementation is illustrated in FIG. 1. The network 10 can include various services or calls between the network elements 12. Each service can be at any of the L0, L1, L2, and/or L3 protocols, such as a wavelength, a Subnetwork Connection (SNC), an LSP, a tunnel, a connection, etc., and each service is an end-to-end path and from the view of the client signal contained therein, it is seen as a single network segment. The network 10 is illustrated, for example, as an interconnected mesh network, and those of ordinary skill in the art will recognize the network 10 can include other architectures, with additional network elements 12 or with fewer network elements 12, etc. as well as with various different interconnection topologies and architectures.

The network 10 can include a control plane operating on and/or between the network elements 12. The control plane includes software, processes, algorithms, etc. that control configurable features of the network 10, such as automating discovery of the network elements 12, capacity on the links 14, port availability on the network elements 12, connectivity between ports; dissemination of topology and bandwidth information between the network elements 12; calculation and creation of paths for calls or services; network-level protection and restoration; and the like. In an embodiment, the control plane can utilize Automatically Switched Optical Network (ASON) as defined in G.8080/Y.1304, Architecture for the automatically switched optical network (ASON) (02/2005), the contents of which are herein incorporated by reference; Generalized Multi-Protocol Label Switching (GMPLS) Architecture as defined in Request for Comments (RFC): 3945 (10/2004) and the like, the contents of which are herein incorporated by reference; Optical Signaling and Routing Protocol (OSRP) which is an optical signaling and routing protocol similar to PNNI (Private Network-to-Network Interface) and MPLS; or any other type control plane for controlling network elements at multiple layers, and establishing and maintaining connections between nodes. Those of ordinary skill in the art will recognize the network 10 and the control plane can utilize any type of control plane for controlling the network elements 12 and establishing, maintaining, and restoring calls or services between the nodes 12. In another embodiment, the network 10 can include a Software-Defined Networking (SDN) controller for centralized control. In a further embodiment, the network 10 can include hybrid control between the control plane and the SDN controller. In yet a further embodiment, the network 10 can include a Network Management System (NMS), Element Management System (EMS), Path Computation Element (PCE), etc. That is, the present disclosure is not limited to a control plane, SDN, PCE, etc. based path computation technique.

### Example Network Element/Node

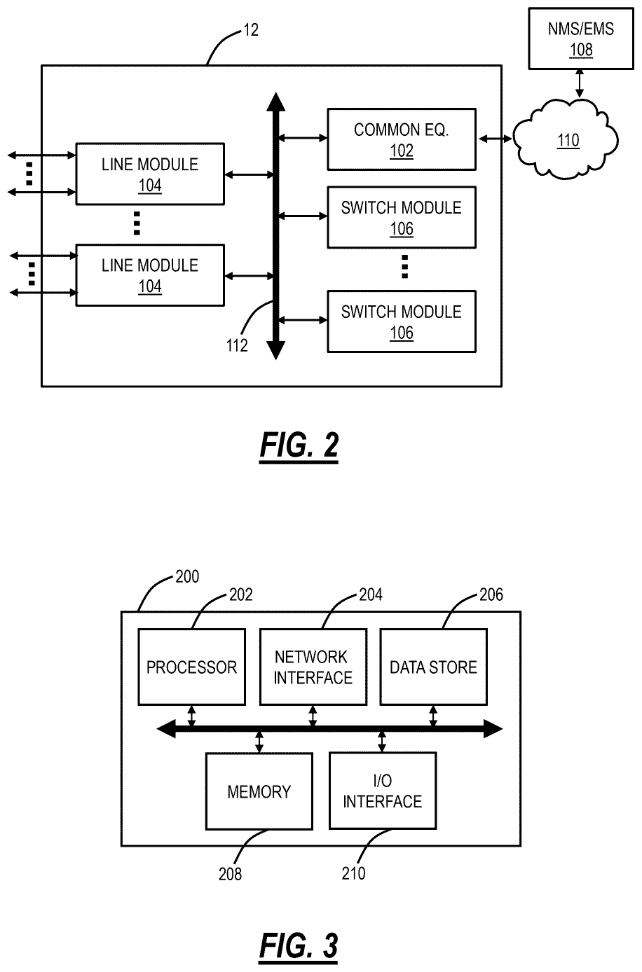

FIG. 2 is a block diagram of an example network element 12 (node) for use with the systems and methods described herein. In an embodiment, the network element 12 can be a device that may consolidate the functionality of a Multi-Service Provisioning Platform (MSPP), Digital Cross-Connect (DCS), Ethernet and/or Optical Transport Network (OTN) switch, Wave Division Multiplexed (WDM)/DWDM platform, Packet Optical Transport System (POTS), etc. into a single, high-capacity intelligent switching system providing Layer 0, 1, 2, and/or 3 consolidation. In another embodiment, the network element 12 can be any of an OTN Add/Drop Multiplexer (ADM), a Multi-Service Provisioning Platform (MSPP), a Digital Cross-Connect (DCS), an optical cross-connect, a POTS, an optical switch, a router, a switch, a WDM/DWDM terminal, an access/aggregation device, etc. That is, the network element 12 can be any digital and/or optical system with ingress and egress digital and/or optical signals and switching of channels, timeslots, tributary units, wavelengths, etc.

In an embodiment, the network element 12 includes common equipment 102, one or more line modules 104, and one or more switch modules 106. The common equipment 102 can include power; a control module; Operations, Administration, Maintenance, and Provisioning (OAM&P) access; user interface ports; and the like. The common equipment 102 can connect to a management system 108 through a data communication network 110 (as well as a PCE, an SDN controller, etc.). Additionally, the common equipment 102 can include a control plane processor, such as a controller 200 illustrated in FIG. 3 configured to operate the control plane as described herein. The network element 12 can include an interface 112 for communicatively coupling the common equipment 102, the line modules 104, and the switch modules 106 to one another. For example, the interface 112 can be a backplane, midplane, a bus, optical and/or electrical connectors, or the like. The line modules 104 are configured to provide ingress and egress to the switch modules 106 and to external connections on the links to/from the network element 12. Other configurations and/or architectures are also contemplated.

Further, the line modules 104 can include a plurality of optical connections per module, and each module may include a flexible rate support for any type of connection. The line modules 104 can include WDM interfaces, short-reach interfaces, and the like, and can connect to other line modules 104 on remote network elements, end clients, edge routers, and the like, e.g., forming connections on the links in the network 10. From a logical perspective, the line modules 104 provides ingress and egress ports to the network element 12, and each line module 104 can include one or more physical ports. The switch modules 106 are configured to switch channels, timeslots, tributary units, packets, etc. between the line modules 104. For example, the switch modules 106 can provide wavelength granularity (Layer 0 switching); OTN granularity; Ethernet granularity; and the like. Specifically, the switch modules 106 can include Time Division Multiplexed (TDM) (i.e., circuit switching) and/or packet switching engines.

Those of ordinary skill in the art will recognize the network element 12 can include other components which are omitted for illustration purposes, and that the systems and methods described herein are contemplated for use with a plurality of different network elements with the network element 12 presented as an example type of network element. For example, in another embodiment, the network element 12 may not include the switch modules 106, but rather have the corresponding functionality in the line modules 104 (or some equivalent) in a distributed fashion. Also, the network element 12 may omit the switch modules 106 and that functionality, such as in a DWDM terminal. For the network element 12, other architectures providing ingress, egress, and switching are also contemplated for the systems and methods described herein. In general, the systems and methods described herein contemplate use with any network element, and the network element 12 is merely presented as an example for the systems and methods described herein.

### Example Controller

FIG. 3 is a block diagram of a controller 200 which can form a controller for the network element 12, a PCE, an SDN controller, a management system, or the like. The controller 200 can be part of the common equipment, such as common equipment 102 in the network element 12, or a stand-alone device communicatively coupled to the network element 12 via the data communication network 110. In a stand-alone configuration, the controller 200 can be the management system 108, a PCE, etc. The controller 200 can include a processor 202 which is a hardware device for executing software instructions such as operating the control plane. The processor 202 can be any custom made or commercially available processor, a central processing unit (CPU), an auxiliary processor among several processors associated with the controller 200, a semiconductor-based microprocessor (in the form of a microchip or chipset), or generally any device for executing software instructions. When the controller 200 is in operation, the processor 202 is configured to execute software stored within the memory, to communicate data to and from the memory, and to generally control operations of the controller 200 pursuant to the software instructions. The controller 200 can also include a network interface 204, a data store 206, memory 208, an I/O interface 210, and the like, all of which are communicatively coupled to one another and to the processor 202.

The network interface 204 can be used to enable the controller 200 to communicate on a Data Communication Network (DCN), such as to communicate control plane information to other controllers, to a management system, to the network elements 12, and the like. The network interface 204 can include, for example, an Ethernet module. The network interface 204 can include address, control, and/or data connections to enable appropriate communications on the network. The data store 206 can be used to store data, such as control plane information, provisioning data, OAM&P data, etc. The data store 206 can include any of volatile memory elements (e.g., random access memory (RAM, such as DRAM, SRAM, SDRAM, and the like), nonvolatile memory elements (e.g., ROM, hard drive, flash drive, CDROM, and the like), and combinations thereof. Moreover, the data store 206 can incorporate electronic, magnetic, optical, and/or other types of storage media. The memory 208 can include any of volatile memory elements (e.g., random access memory (RAM, such as DRAM, SRAM, SDRAM, etc.), nonvolatile memory elements (e.g., ROM, hard drive, flash drive, CDROM, etc.), and combinations thereof. Moreover, the memory 208 may incorporate electronic, magnetic, optical, and/or other types of storage media. Note that the memory 208 can have a distributed architecture, where various components are situated remotely from one another, but may be accessed by the processor 202. The I/O interface 210 includes components for the controller 200 to communicate with other devices. Further, the I/O interface 210 includes components for the controller 200 to communicate with the other nodes, such as using overhead associated with OTN signals.

The controller 200 is configured to implement software, processes, algorithms, etc. that can control configurable features of the network 10, such as automating discovery of the network elements 12, capacity on the links 14, port availability on the network elements 12, connectivity between ports; dissemination of topology and bandwidth information between the network elements 12; path computation and creation for connections; network-level protection and restoration; and the like. As part of these functions, the controller 200 can include a topology database that maintains the current topology of the network 10, such as based on control plane signaling and a connection database that maintains available bandwidth on the links again based on the control plane signaling as well as management of the network, connectivity between ports; dissemination of topology and bandwidth information between the network elements 12; path computation and creation for connections; network-level protection and restoration; and the like. As part of these functions, the controller 200 can include a topology database that maintains the current topology of the network 10, such as based on control plane signaling and a connection database that maintains available bandwidth on the links again based on the control plane signaling as well as management of the network.

The present disclosure contemplates path computation via the controller 200 in a network element 12, via a PCE, NMS, EMS, SDN controller, and the like, etc.

### Network Routing Optimization Using Network Digital Twins

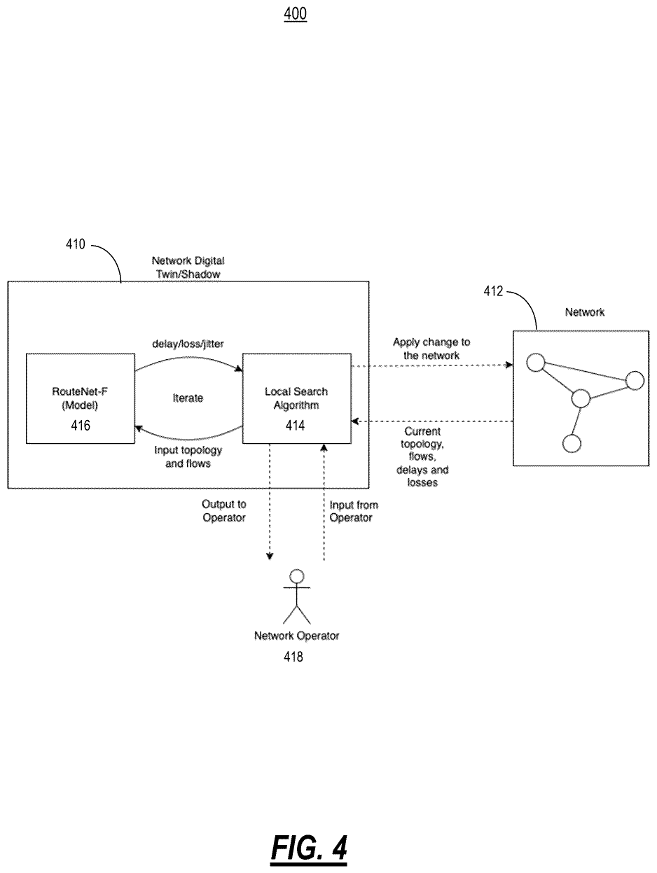

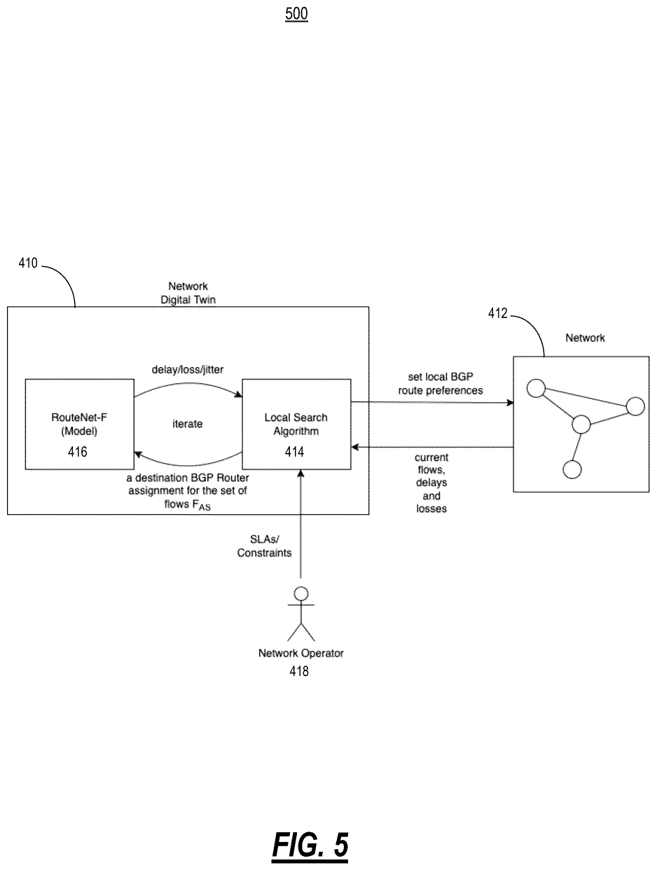

Turning now to FIGS. 4 & 5, a schematic 400 and an alternative schematic 500 of an example of an NDT architecture 410 is shown and described. Some aspects of the present disclosure pertain to a general architecture of a Network Digital Twin (NDT 410) and a methodology for adapting the same to different network optimizations 412 by, for example, adjusting an optimizer component. More generally, FIGS. 4 & 5 depicts a high-level architecture of the NDT 410. The NDT 410 can include a Graph Neural Network (GNN)-based Machine Learning (ML) model, which can predict the average Quality of Service (QoS) metrics per flow, such as delay, loss, and jitter, combined with a local search algorithm 414 that can take different inputs based on the specific problem and computes a solution by iterating over the output space. Depending on the problem, the solution can either be applied directly to the real network or provided to a network operator 418.

One aspect pertains to BGP route selection, network fault localization, topology planning, and what-if failure analysis. For a given problem, the NDT's local search algorithm 414 can be adapted to solve the problem efficiently. The methodology also allows for solving multiple problems simultaneously. The high-level breakdown of the problems addressed by the system of the present disclosure is as follows: BGP Route Selection or selecting destination BGP routers for flows to meet delay, loss and utilization constraints while optimizing QoS metrics, such as average traffic delay, Network Fault Localization such as identifying faulty links or devices in the network using a digital shadow that monitors traffic flow information. The system can also address Network Topology Planning, such as finding a network topology that meets a set of constraints provided by the network architect while minimizing costs, What-if Failure Analysis such as identifying critical links or nodes whose failure would impact network traffic the most, allowing for efficient capacity planning and network upgrades. More generally, the present disclosure provides a solution for network optimization and management by way of leveraging one or more of ML and local search algorithms. The NDT 410 can include a ML model RouteNet-F 416, which can be configured to predict QoS metrics for network flows.

In typical aspects, the present disclosure provides a method including the application of a GNN-based Network Digital Twin to solve networking problems. Such networking problems can include without limitation considering link utilization as well as QoS metrics such as delay, jitter, and loss, BGP Route Selection, Iteration over many BGP route scenarios, computing the QoS metrics in each, optimizing the choice of BGP route selections to meet delay, loss and utilization constraints while optimizing QoS metrics, such as average traffic delay or loss. Other network problems can be without limitation Network Fault Localization or use of the discrepancy in the QoS metrics predicted by the GNN model compared to those in the real network to identify faulty traffic flows, use of a triangulation method to localize specific nodes or devices which are causing the QoS degradation of the flows. Other network problems can include Network Topology Planning or iteration over many candidate network topologies, computing the expected QoS metrics in each scenario, optimizing the choice of candidate network topology to meet delay, loss and utilization constraints while optimizing QoS metrics, such as average traffic delay or loss or application to either green field deployments or pre-existing networks. Yet further examples of networking problems can include what-if Failure Analysis such as Iteration over many failure scenarios, computing the expected QoS metrics in each scenario such as the flagging of nodes or links which would cause significant faults in the QoS or SLAs in the network as critical, ranking the critical nodes or links by their effect on QoS metrics and providing this ranked list to the network operator 418/planner.

In general, one advantage of the methods presented in this disclosure over the prior art is the ability to solve these problems much more quickly (up to 500 times faster) due to the use of a pre-trained GNN instead of a traditional simulation. As such, the system can take into consideration the QoS metrics of the traffic flows, such as loss, latency, and jitter, rather than only the link utilization. The following is a high-level description of how the method and/or algorithm can be used to solve each problem. Selection of BGP Routing: For this problem, the inputs to our NDT 410 are the current flows in the network and any SLAs/constraints required from the operator. The NDT 410 can iterate over BGP router assignments for all flows which have an external Autonomous System (AS) as their destination, in each scenario computing the delay, loss, and jitter for all flows in the network. As such, the average delay per flow can be minimized while maintaining conformance to constraints on each flow's delay and loss, and the utilization of each link.

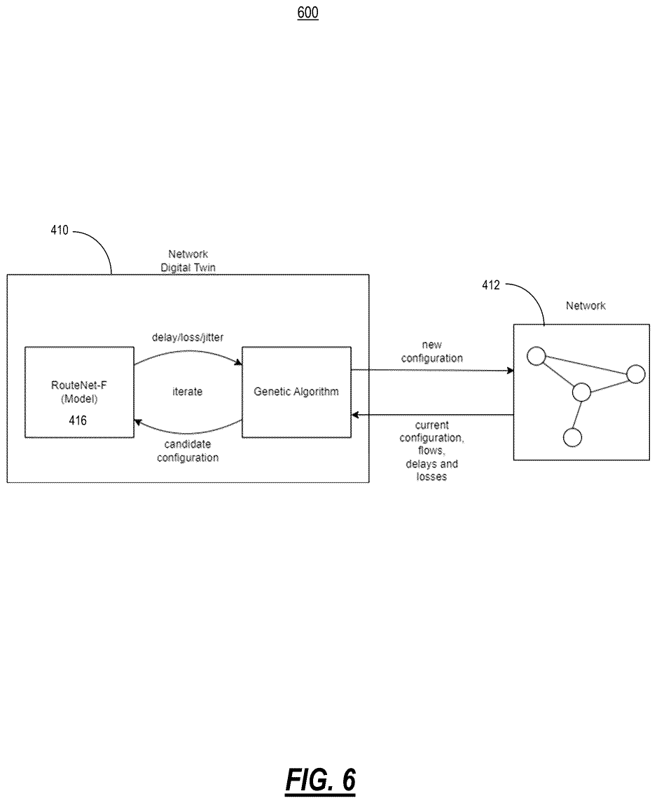

Turning now to FIG. 6, an alternative schematic 600 of the example NDT 410 architecture of FIG. 1 depicting exemplary setting IGP weights is shown and described. In some aspects, the NDT 410 architecture can be used to localize faults in the network. This solution is especially useful for silent failures (aka “grey failures”), where a link or device is not experiencing any alarms, but it has degraded enough to affect the services that depend on it. The method can include creating a “digital shadow” of the network. The method can take as input the current network topology, traffic flows, and their delays and losses, and use the ML model to compute the expected delays and losses per flow, given the assumption of a healthy network. The method can identify “faulty flows” in the network by comparing the predicted delays and losses to the corresponding values in the real network. Those that have degraded significantly from the prediction can be marked as faulty. Faulty links or devices can then be localized using a triangulation method to correlate the paths of the flows together, setting the areas with highest overlap with a higher probability of being faulty.

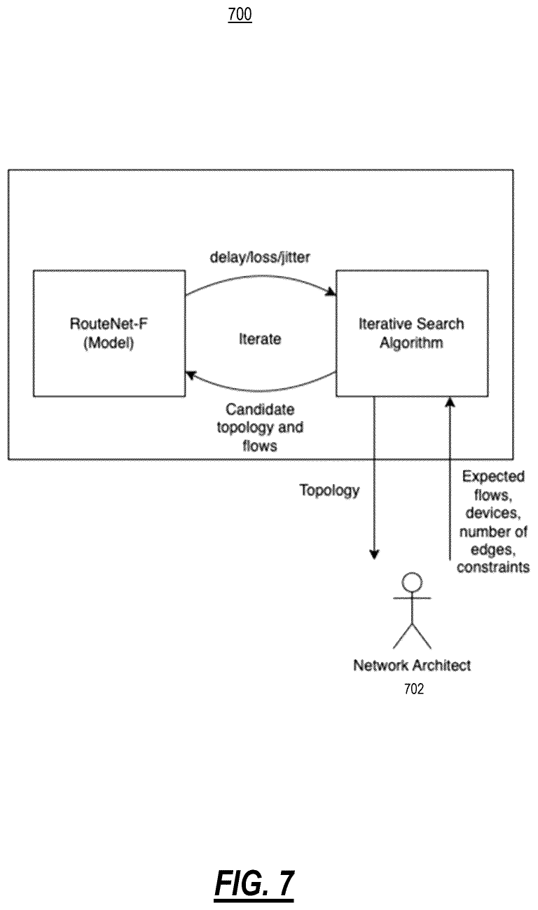

Turning now to FIG. 7, a schematic depicting an example iterative algorithm 700 is shown and described. The present disclosure provides architecture which can also be applied to the problem of topology planning, either for modifications to an existing network, or even for greenfield network deployments. In this case, the inputs could be a list of constraints from the network architect, such as expected flows, number of devices, number of edges, geographical constraints, and any other requirements. The method can then use the NDT 410 to iterate over many possible combinations of network topologies, each time computing the expected delays, losses, jitter for each flow, as well as link utilization. For example, once a graph which satisfies the constraints is found, or a set number of iterations is met, the iteration stops, and the result is presented to the network architect. Such a brute force solution would not generally be possible without the use of our ML-based NDT 410, as it can iterate much more quickly and thus test many more scenarios within a fixed time window compared to NDTs 410 based on traditional simulations.

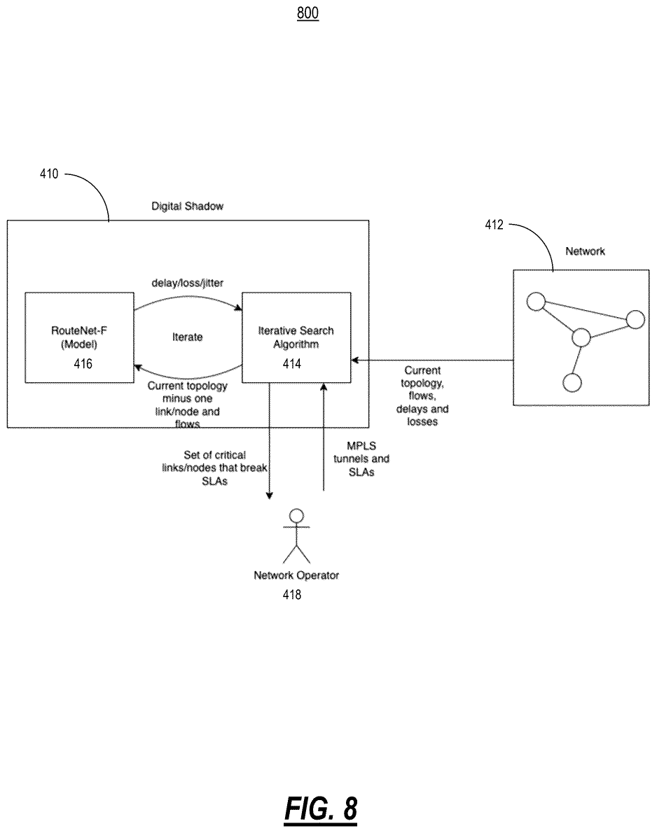

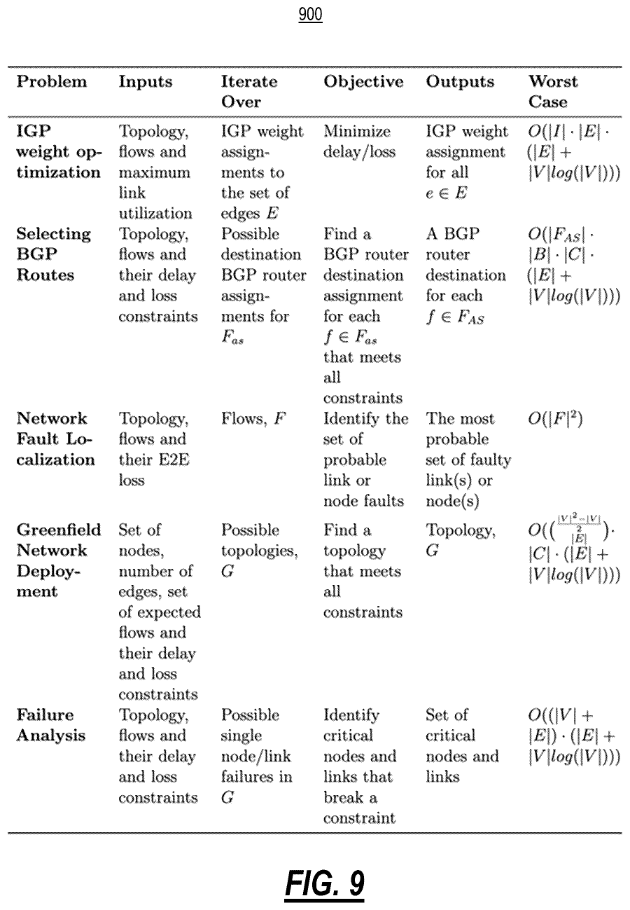

Turning now to FIGS. 8 & 9, an alternate schematic 800 and table 900 depicting an example approach is shown and described. Some aspects of the present disclosure can including performing a failure analysis, where the “what-if” scenarios are tested by iteratively removing one link or node at a time and use the ML model to predict the effect on the delay, loss, and jitter of all of the flows in the network. Scenarios that result in a network that does not satisfy the constraints of the network operator 418 result in that node or link being flagged as “critical” to a network architect 702. At a high level this approach is similar to previous approaches to testing what-if failure scenarios. The main difference is that, since an ML-based NDT 410 approach is incorporated, the method can iterate much faster and thus test many more failure scenarios than simulation-based methods.

### NDT Architecture and Method of Adaptation

The present disclosure provides an architecture having the functionality of NDT and outlines a methodology for adapting it to various network optimization problems by modifying its optimization component. The NDT can integrate a ML model, RouteNet-F, which predicts average QoS metrics for network flows, such as delay, packet loss, and jitter, and a local search algorithm tailored to solve optimization problems by exploring different network configurations. For example, the local search algorithm can evaluate various configurations, such as IGP weight assignments or topologies, to achieve specific objectives like minimizing average delay or meeting QoS constraints.

RouteNet-F can be used because of its ability to generalize across network topologies and outperform other ML-based QoS prediction models. This optimization problem involves assigning IGP weights to network edges to minimize average delay while ensuring no edge utilization exceeds a specified threshold. Due to the intractability of brute-force approaches, stemming from the large search space and computational complexity, a heuristic random search algorithm can be used. This algorithm can iteratively test random IGP weight assignments, predict traffic delays using RouteNet-F, and updates the best configuration when improvements are found.

Additionally, the method can include BGP route assignment optimization. The method can include selecting BGP routers for traffic flows with Autonomous System (AS) destinations, aiming to satisfy SLA constraints while minimizing overall network delay. Given the NP-hard nature of this problem, an incomplete search algorithm can be used to explore the assignment space efficiently. The algorithm can evaluate random BGP router assignments for flows, predicting delays and losses using RouteNet-F, and identifying configurations that satisfy all constraints. The solution with the lowest average delay is then applied to the network or presented to the operator. More generally, the NDT can leverage RouteNet-F for predictive accuracy and heuristic algorithms for scalability.

Some aspects of the present disclosure can include Root Cause Analysis (RCA). In typical aspects, the method can employ RCA in communication networks which can identify specific components, such as links or devices, responsible for network malfunctions, enabling operators to repair or replace them. In some aspects, the system of the disclosure introduces a digital shadow that monitors the network topology and traffic flow information, such as delay and loss, without requiring continuous monitoring of every device and link. Using the provided network topology, traffic flows, and a threshold for absolute percentage error, the system can identify the minimal set of faulty edges or nodes. The method can iteratively analyze flows with discrepancies between predicted and actual loss or delay that exceed the threshold, systematically eliminating unaffected components from the suspected faulty set. The process can include reordering neighboring flows by their deviations and removing components associated with flows below the threshold, ultimately returning the best estimation of faulty links or devices. This approach achieves fault localization while balancing efficiency and accuracy for large-scale networks.

### Gray Failure Detection

One aspect of the present disclosure pertains to NDT configured for finding the minimum set of link(s)/router(s) that most likely contribute to the observed traffic flow latencies/delays. In some aspects, the system uses the topology of the network and the traffic flow information (including its E2E metrics such as delay and loss) obtained from the physical network to identify link failures. In some aspects, the system uses a provided Absolute Percentage Error (APE) threshold, that is used to identify both normal flows and flows experiencing disruptions to find the smallest set of links and edges that most likely contribute to the disruptions. In example, the system can use a trained RouteNet-F model for E2E predictions and makes an assumption that the model accurately predicts the E2E metrics of the network flows under normal operation.

One aspect of the system can use the topology of the network and the traffic flow information, such as E2E (i.e., delay and loss) obtained from the physical network to identify link failures obtained, for example, from the physical network to identify link failures. The system can be configured to find the minimal set of edges and devices where the faulty link/device lies. The foregoing can be formalized as an optimization problem in terms of edges and delays. The objective function can maximize the number of edges in the set of faulty edges instead of minimizing it which is counter intuitive. In instances where two constraints are included, such as one specifying that at least one edge on a ‘faulty’ flow has a fault and another constraint that specifies all edges on a ‘good’ flow are not faulty and it is desired to capture all edges where a fault might lie, the objective maximizes the number of faulty edges to minimize the possibility of false negatives.

This same formalization can be used for nodes and traffic loss as well by replacing the terms for edges with the terms for nodes and the terms for delay with the terms for loss. Using delay predictions can help catch other causes of gray failures that loss predictions cannot. For instance, mis-configured routers with traffic shaping policies, or buffer issues where packets are not dropped but have abnormal delays due to a firmware issue. The system can use a heuristic search algorithm defined by a simplified version of the algorithm in a root cause identification. Given G, F, and Δ, the system can localize the set of faulty link/device by first sorting the flows in descending order of absolute percentage error between predicted delay and the ground truth delay from the network. Then, the system can iterate through the ordered set of flows. If the delay APE of a flow, f, is beyond the threshold Δ, the system can add all links and devices that exist in the path of flow f to the set of faulty links and devices, EVfault. If a flow is below the threshold Δ the system can remove all links and devices that exist in its path from EVfault. One the algorithm terminates it shall return the best guess on where the faulty links/devices are. The worst case scenario of this approach would be O(|F|log(|F|)) when using merge sort.

For illustrative example only, and without limitation, the system can use the absolute percentage error between the predicted and ground truth delay metrics as a threshold. There are cases where using the absolute error between the predicted and ground truth delays is more effective. For instance, when some flows have to traverse much longer paths than the rest of the flows, the percentage difference in delay due to one of the links having a gray failure in those flows will be much lower than the rest. Another limitation is that using the delay alone will not capture all silent failures that result in packet loss. Using the delay metric is useful for identifying misconfigured routers with issues such as: a traffic policy limiting bandwidth on one of the interfaces silently, a firmware bug delaying the processing of packets in a port, etc. The system can also assume that the final destination of the flow is reached with at least some of the packets in order to get the ground truth delay from the physical network.

The present application provides NDT for identifying link faults by passively collecting current flow information including their E2E metric (i.e., specific delay) and using prediction from the NDT's model (i.e., RouteNet-F) to identify misbehaving flows in the network. The system can use a fault localization algorithm configured to iterate through all the flows to classify links such as, for example, faulty or normal based on a provided APR threshold. The system can be configured to identify both single link failures and multiple link failures. It is envisioned that either an APE or absolute error as a threshold for identifying faulty flows, and that the system can work using loss measurements and prediction by replacing terms for delay with loss.

More generally, the disclosure provides an NDT architecture which can be configured to leverage a GNN-based machine learning model (e.g., RouteNet-F) and one or more local search algorithms to optimize network performance, predict QoS metric, and solve various network issues efficiently. In typical aspects, the disclosure provides BGP route selection. The BGP route selection can be configured to optimize routing to minimize delay, loss, and jitter and can meet QoS constraints. Embodiments can include network fault localization which can identify faulty links or devices using a digital shadow by comparing predicted and actual QoS metric, employing triangulation to pinpoint issues (e.g., grey failures) and improve the stability of the network. The method can be adapted for topology planning wherein the method can design or modify network layouts to meet constraints while minimizing costs. As such, the method can leverage rapid iteration over configuration.

In some aspects, the disclosure provides a method which can predict impacts of node/link failures, rank critical components for capacity planning and upgrade, and other network tasks. The method can include an RCA evaluation wherein the method identifies specific faulty components in large networks by analyzing discrepancies between predicted and observed network behavior. More generally, the present disclosure provides improvements to traditional methods by iterating (e.g., 500 times faster) and providing scalability and predictive accuracy. As such, the method can address multiple problems including silent failures, misconfigured routers, and capacity constraints by, for example, using heuristic algorithms and adaptive methods to meet operator-defined constraints.

In some aspects, the method includes analyzing network faults using a combination of digital modeling and machine learning. The method can include creating the digital shadow which can refer to building a virtual representation or model of a physical network. The digital shadow can include current network topologies (i.e., the structure and layout of the network such as nodes, links, or configurations), traffic flows (i.e., data transfer patterns across the network), and delays and losses (i.e., performance metrics such as packet delays and data loss rates. The creating step can be important for simulating the network environment and can permit fault analysis without directly interfering with the real network.

The method can include computing via the machine learning model, for example computing an expected delay and losses per flow. The machine learning model can be trained on historical network performance data to predict how the network should behave under normal conditions. For example, the machine learning model can predict the time it takes for data to travel through the network or predict percentage of data packets lost during transmission. This can help establish a baseline of “normal” network behavior for comparison. The method can include a comparing step, wherein the one or more expected delays are compared to a value in a real network to define one or more faulty flows. This step can include real-time monitoring of the actual network's performance and comparing it to the baseline predictions from the machine learning model. If, for example the real network shows a delay or loss that deviate within a threshold from the machine learning model, it can indicate such as a faulty flow or specific data streams which are experiencing loss. This comparison can highlight where the network's performance differs from what is expected, narrowing down the source of potential problems.

The method can include localizing one or more faulty links. Once faulty flows are identified, the system can isolate the specific links or network components causing the issue. This can include tracing traffic paths for the faulty flows, analyzing the performance of individual links or node to find anomalies, (e.g., unusually high delays or packet losses), or other similar approaches. The goal is to pinpoint the root cause of the fault, allowing network operators to address the issue efficiently. More generally, the method leverages the digital twin or digital shadow and machine learning to detect, diagnose, and localize network faults. For example, the method can compare real-time network performance against a predictive model which can enable proactive and accurate fault analysis, improve the efficiency of network maintenance, and minimize down time. As such, the exemplary methods of the present disclosure can combine simulation, predictive analytics, and real-world monitoring to deliver a robust fault-detection mechanism.

In some aspects, the digital shadow (or digital model) of the network is not static but is dynamically updated using real-time data. This can ensure the model reflects the current state of the actual network. Real-time data can include live performance metrics such as bandwidth usage, traffic patterns, packet delays, losses, link statuses, etc. By incorporating real-time data, the digital shadow can become highly accurate and up to date in its representation of the physical network. The real-time data can be gathered using network monitoring tools, which can be configured to observe and managing network performance. Examples of the foregoing can include without limitation Simple Network Management Protocol (SNMP) (e.g., tools for gathering performance metrics from network devices), packet analyzers (e.g., wireshark, or any program for capturing and analyzing data packets), flow monitors (e.g., NetFlow, sFlow, or any other program for observing traffic flows across the network), or application performance monitoring tools for evaluating specific application traffic. These tools can be adapted to feed live data into the system, which can then be used to update the digital shadow, for example continuously.

In some aspects, the disclosure includes a fault localization process which includes triangulations. Further, the triangulation can include analyzing correlations between delays and losses across multiple flows. Such triangulation can include leveraging data from one or more vantage points within the network (e.g., different traffic flows or nodes) to pinpoint the faulty link or area causing abnormal performance. More specifically, the method can include examining the relationship between delays and losses observed in various flows and can identify patterns or anomalies which suggest where the fault originates. For example, if multiple flows passing through a common link exhibit similar delay or loss characteristics, that link can be identified as the source of the issue. This correlation-based approach enhances the precision of fault localization, especially in complex networks, by cross-referencing data from the digital shadow and real-time metrics to isolate faults with higher confidence.

The method can include a digital shadow is updated responsive to a change in topologies or traffic patterns. This can refer to the dynamic and adaptive nature of the NDT. More specifically, the “digital shadow” can be a virtual representation of the real network that monitors and predicts network behavior, including QoS metrics like delay, jitter, and packet loss. In example only, and without limitation, when there is a change in topologies (e.g., addition/removal of nodes, reconfiguration of links) or traffic patterns (e.g., shifts in flow volume, rerouting of traffic), the system updates the digital shadow to ensure it accurately reflects the current state of the physical network. This update can allow the NDT to recompute predictions, perform fault localization, optimize adaptation, and increase scalability and real-time updates. More specifically, the updating can adjust predictions of QoS metrics for network flows based on the new topology or traffic conditions using the pre-trained Machine Learning (ML) model (e.g., RouteNet-F). In some aspects, the updating can Identify any new faults that may arise due to the changes, such as degraded links or devices that were previously functioning normally or can reapply or modify optimization algorithms, such as for BGP route selection, topology planning, or failure analysis, to account for the updated network state. The use of the ML model allows the system to process changes quickly and adapt in near real-time, providing updated solutions or recommendations to network operators without the delays of traditional simulation-based methods.

In some aspects, the method can include prioritizing faulty flows based on a predefined QoS threshold. Such a step defines the system's ability to identify and address network issues by evaluating flows against predetermined benchmarks of QoS metrics, such as delay, jitter, throughput, and packet loss. For example, when the network flow fails to meet these QoS thresholds, it can be flagged as “faulty.” The system then prioritizes these faulty flows for further analysis and corrective action based on their level of deviation from the thresholds or their importance to overall network performance. This prioritization process enables efficient fault diagnostics, dynamic updates, predefined QoS thresholds, and improved decision making. By focusing on flows with the most critical QoS violations, the system can ensure that resources are allocated to resolving the most impactful issues first. Further, by using the NDT, the system can continuously evaluate the flows and adjust prioritization in real-time as new faults emerge or as conditions improve. The thresholds can be set according to network policies, service-level agreements, or user requirements, and can provide clear criteria for determining what constitutes a fault. With prioritization, network operations can focus on resolving high-impact flows, such as those critical to business or latency-sensitive applications, while deprioritizing less significant issues.

In typical aspects, the system can include expected delays and losses which are computed based on traffic flow characteristics defined by packet size and protocol type. More specifically, the disclosure provides a mechanism within a system which can calculate anticipated network performance metrics, or specific delays and packet losses by analyzing the attributes of the traffic flows. This computation process can consider packet size, protocol type, traffic flow characteristics, integration with the digital shadow, or the like. Larger packets may require more time to transmit and are more susceptible to delays in congested networks. Conversely, smaller packets may experience lower delays but might increase overhead. Different protocols (e.g., TCP, UDP, or ICMP) have distinct transmission behaviors and requirements. For instance, TCP involves acknowledgement and retransmission mechanisms, which influence delays and losses while UDP prioritizes low latency but lacks reliability features, making it more prone to packet loss. By analyzing these elements, the system predicts how specific types of traffic will behave under current network conditions. This includes factors like transmission queues, congestion levels, and the effects of routing decisions. The system incorporates real-time network data via the NDT, ensuring that these calculations reflect the latest topology, traffic patterns, and performance metrics. By knowing expected delays and losses, the system can implement measures like traffic shaping or rerouting to maintain performance. These predictions assist in ensuring compliance with predefined Quality of Service (QoS) thresholds, as they help determine whether current network configurations meet service-level expectations.

In some aspects, the method can include generating a graphical representation of the digital shadow to visualize identified faulty flows and links. More specifically, the system can include a visual interface to display network conditions which can highlight problematic areas such as faulty traffic flows or links. More specifically, the system can include graphical representation, which can translate the digital shadow, a virtual model of the network, into a visual format. This can include nodes and links which represent devices (e.g., router, switches) as nodes in their connection as lings, flow paths which illustrate the path traffic takes across the network, or the like. The system can include the identification of faults. These are specifically data streams or traffic patterns experiencing issues such as delays, packet loss, or protocol mismatches. Physical or logical connections in the network exhibiting problems, such as congestion, failures, or degraded performance can also be identified. The system can highlight problematic areas, through a visualization, which can include distinct markets (e.g., colors, icons, or animations) to emphasize or communicate faulty flows to links. For instance, a link with packet loss might appear as red or flashing in the graphical representation. By leveraging the digital shadow's dynamic data, the graphical representation updates in real time to reflect current network conditions. This ensures accuracy and immediacy in fault identification. As a result, network operators can trouble show or quickly identify and address issues by visually pinpointing faults in the system. The visualization provides insights into traffic behavior, helping enforce QoS thresholds and ensuring smooth network operation. By analyzing the visual data, the system can proactively alert operators to potential issues before they escalate.

In typical aspects, the method can include localizing faulty links by comparing real-time delay and loss metrics across a redundant or an alternate path. More specifically, the system provides identifying problematic network connections (faulty links) by analyzing performance differences between primary and backup paths in real-time. The system can localize faulty links by pinpointing specific network links causing ussies, such as excessive delays or packet loss, by systematically evaluating their performance. The system can provide comparisons of metrics by continuously monitoring performance such as delay (e.g., the time it takes for packets to travel across a link) and loss (e.g., the percentage of packets dropped or not delivered successfully). These metrics can be used to determine whether a specific link is underperforming. The method can use redundant or alternative paths, having backup paths which mirror the primary network route or different routes the system can take to reroute traffic. By comparing the metrics of the primary path with those of redundant or alternate paths, the system identifies discrepancies that point to a faulty link. The system provides a fault localization process wherein the system analyzes each segment of the network path. When a link along the primary path shows significantly worse performance (higher delays or losses) than its corresponding segment in a redundant or alternate path, it is flagged as faulty. Application of the method include increasing network resilient, or the ability to isolate faulty links ensures minimal disruption by quickly rerouting traffic through unaffected paths, continuous tracking of delays and losses helps maintain network reliability, or localizing issues in real time, where network operators can resolve faults before they escalate or impact service quality.

In typical aspects, the method can include the ML model being configured to update the computations responsive to feedback from manual or automated fault corrections. More specifically, the system can include a dynamic where the ML mode can adapt and improve its performance by learning from corrections made to identified faults, either through human intervention (manual corrections) or automated systems (automated corrections). The system uses an ML model to make predictions, optimizations, or decisions based on the data it receives, such as network performance metrics, traffic patterns, or fault conditions. This model can identify trends, predict future behaviors, or even detect anomalies that may signify issues like faulty network links or traffic bottlenecks. The model is designed to adjust its computations or predictions in response to new information, which is derived from how faults are corrected. The updating computation can refer to network performance predictions, estimations of delays or losses, or fault detection parameters. The key feature is that the ML model responds or adapts based on feedback about the accuracy or success of its prior predictions or corrections. This feedback loop enhances the model's ability to make more accurate predictions over time. The feedback can be human intervention in fixing a fault which provides feedback to the model. For example, if a network engineer manually corrects a faulty link by rerouting traffic, the model learns from this action to adjust its future predictions or fault identification processes. On the other hand, when automated systems, such as self-healing network mechanisms, detect and resolve issues (like rerouting traffic away from a congested path), this also provides feedback to the ML model. The model uses this feedback to learn the effectiveness of the correction and improve its ability to predict or resolve similar issues in the future. As the model receives more feedback (both positive and negative), it continuously refines its approach, becoming more accurate and efficient over time. This dynamic learning process allows the system to evolve and handle new scenarios more effectively. As the system learns from corrections, it becomes better at identifying faults in the future and providing more reliable fault localization. With real-time feedback, the system can adjust its traffic management, fault mitigation, and optimization strategies. The continuous updating ensures that the system adapts to changes in the network environment, reducing the likelihood of recurring issues.

### Method

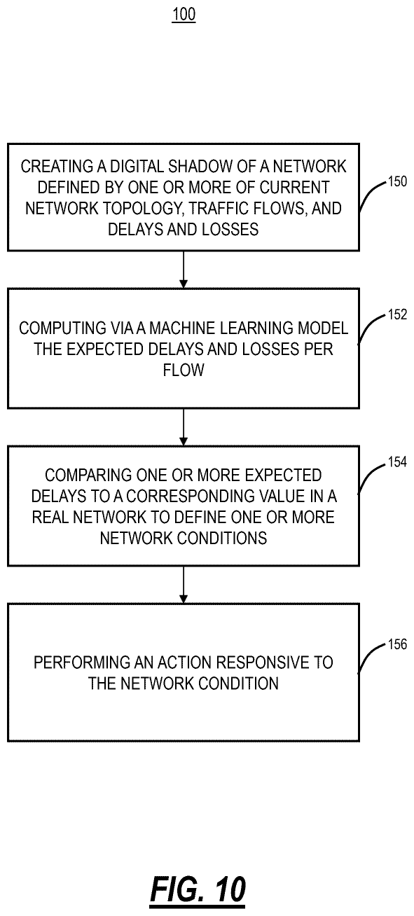

Turning now to FIG. 10, an example method 100 in accordance with an aspect of the present disclosure is shown and described. The method can include using the NDT to localize faults in the network. This solution is especially useful for silent failures (aka “grey failures”), where a link or device is not experiencing any alarms, but it has degraded enough to affect the services that depend on it. The method can include creating a digital shadow of the network. The method can include inputting a current network topology, traffic flows, and their delays and losses. The method can include using a ML model to compute the expected delays and losses per flow, optionally based on an assumption of a healthy network.

The method can include identifying “faulty flows” in the network by comparing the predicted delays and losses to the corresponding values in the real network. In such example, those that have degraded significantly from the prediction can be marked as faulty. In some methods, faulty links or devices can be localized using a triangulation method to correlate the paths of the flows together. The method can include setting the areas with the highest overlap with a higher probability of being faulty. It should be noted that such triangulation can be a method to identify common root cause for multiple degraded services. The method can include comparing one or more expected delays to a corresponding value in a real network to define one or more network condition, and performing an action responsive to the network condition.

In some aspects, the method can be applied to topology planning, for example as a modification to an existing network or for greenfield network deployments. The method can include an input having a list of constraints from the network architecture, such as expected flows, number of devices, number of edges, geographical constraints, and any other requirements. The method can then use the NDT to iterate over a plurality of possible combinations of network topologies. In example, the iteration can compute the expected delays, losses, jitter, etc. for each flow as well as link utilization. Once a graph which satisfies the constraints is found, or a set number of iterations is met, the iteration stops, and the result is presented to the network architect.

In some aspects, the method can perform a failure analysis. The failure analysis can be a “what-if” scenario that can be accomplished by iteratively removing one link or node at a time. The method can also use the ML model to predict the effect on the delay, loss, and jitter of all the flows in the network. Scenarios that result in a network that does not satisfy the constraints of the network operator result in that node or link being flagged as “critical” to the network architect.

In some methods, the inputs to the NDT are the current flows in the network and any SLAs/constraints required from the operator. The NDT iterates over BGP router assignments for all flows which have an external autonomous system as their destination, in each scenario computing the delay, loss, and jitter for all flows in the network. Again, it is noted that the present disclosure incorporates a GNN-based NDT to solve network problems.

In some aspects, the method can address BGP route selection by iterating over multiple scenarios to compute QoS metrics such as delay, loss, and utilization for each flow. The method can optimize route selections to satisfy network constraints and improve overall performance. Once an optimal configuration is identified, the results can be provided to the network operator. In some aspects, the method can perform fault localization by comparing QoS metrics predicted by the GNN model with real network data to identify discrepancies. These discrepancies can be used to locate faulty flows, and a triangulation method can further pinpoint specific devices or nodes causing the issues.

In some aspects, the method can support network topology planning by iterating over candidate network designs and calculating QoS metrics for each. The method can identify topologies that satisfy constraints such as delay, loss, and utilization, and present them for use in greenfield deployments or modifications to existing networks. In some aspects, the method can conduct what-if failure analysis by simulating potential node or link failures and predicting their impact on QoS metrics. Nodes or links critical to maintaining SLAs can be flagged and ranked by their importance, providing actionable insights for network planning.

In some aspects, the disclosure provides exemplary methods for network fault analysis, including creating 150 a digital shadow of a network defining one or more of current network topologies, traffic flows, and delays and losses, computing 152 via a machine learning model an expected delays and losses per flow, comparing 154 one or more expected delays to a corresponding value in a real network to define one or more network conditions, and performing an action 156 responsive to the network conditions.

The method can include wherein the creating the digital shadow includes receiving real-time data from a one or more network monitoring tools. The method can include wherein the localizing is accomplished via a triangulation. The method can include wherein the triangulation includes analyzing a correlation between delays and losses across one or more flows.

The method can include wherein the digital shadow is updated responsive to a change in topologies or traffic patterns. The method can include prioritizing faulty flows based on predefined quality-of-service thresholds. The method can include wherein the expected delays and losses are computed based on traffic flow characteristics defined by any of packet size, protocol type, service type, bandwidth, and time distribution.

The method can include generating a graphical representation of the digital shadow to visualize identified faulty flows and links. The method can include wherein the faulty links are localized by comparing real-time delay and loss metric across a redundant or alternate path. The method can include wherein the machine learning model is configured to update the computations responsive to feedback from manual or automated fault corrections.

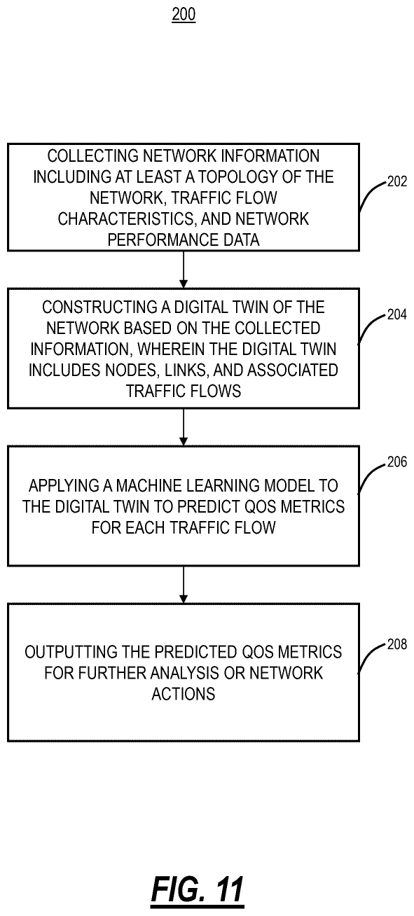

Turning now to FIG. 11, an example method 200 in accordance with an aspect of the present disclosure is shown and described. The method 200 is for generating a network digital twin to predict Quality of Service (QoS) metrics for a network, and includes collecting 202 network information including at least a topology of the network, traffic flow characteristics, and network performance data; constructing 204 a digital twin of the network based on the collected information, wherein the digital twin includes nodes, links, and associated traffic flows; applying 206 a machine learning model to the digital twin to predict QoS metrics for each traffic flow; and outputting 208 the predicted QoS metrics for further analysis or network actions.

The method 200 can further include comparing the predicted QoS metrics with corresponding QoS metrics measured from the network; identifying one or more discrepancies between the predicted QoS metrics and the measured QoS metrics; and localizing, based on the discrepancies, one or more potential faults in at least one link, node, or device in the network.

The method 200 can further include iterating over different Border Gateway Protocol (BGP) routing assignments for traffic flows in the network; computing the predicted QoS metrics using the machine learning model; and selecting an optimal routing assignment that satisfies one or more QoS constraints, wherein the constraints include at least one of delay, packet loss, or link utilization.

The method 200 can further include iterating over potential network topologies during network planning; computing, for each potential network topology, the predicted QoS metrics for traffic flows using the digital twin; and selecting a candidate network topology that satisfies one or more performance constraints. The constraints can include at least one of average network delay, packet loss thresholds, cost, or device count.

The method 200 can further include iterating over one or more failure scenarios by removing or disabling at least one link or node in the digital twin; predicting, for each failure scenario, the resulting QoS metrics using the machine learning model; and identifying one or more critical nodes or links whose removal leads to a violation of at least one QoS constraint. The method 200 can further include flagging the identified critical nodes or links for priority maintenance, upgrade, or protection planning.

The QoS metrics can include one or more of: delay, packet loss, jitter, link utilization, or throughput. The machine learning model can be a Graph Neural Network (GNN) trained on historical flow data to generalize QoS predictions across multiple topologies and traffic patterns without requiring per-scenario re-training. The traffic flow characteristics can include at least any one or combination of a size of data packets, protocol type, bandwidth requirements, end-to-end latency requirements, or jitter constraints.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown in the drawings, descriptions, and claims in a specific order, this does not imply they must be performed in that sequence unless explicitly stated. It also does not imply that all depicted operations are necessary to achieve desirable results. The drawings may schematically represent example processes such as flowcharts or diagrams, and additional operations not shown can be included. In the drawings, descriptions, and claims, extra steps can occur before, after, simultaneously with, or between any of the illustrated, described, or claimed steps. Multitasking and parallel processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable manner—whether collectively, in subsets, or individually—thereby broadening the range of potential embodiments.

What is claimed is:

1. A method for generating a network digital twin to predict Quality of Service (QoS) metrics for a network, the method comprising:
collecting network information including at least a topology of the network, traffic flow characteristics, and network performance data;
constructing a digital twin of the network based on the collected information, wherein the digital twin includes nodes, links, and associated traffic flows;
applying a machine learning model to the digital twin to predict QoS metrics for each traffic flow; and
outputting the predicted QoS metrics for further analysis or network actions.

2. The method of claim 1, further comprising
comparing the predicted QoS metrics with corresponding QoS metrics measured from the network;
identifying one or more discrepancies between the predicted QoS metrics and the measured QoS metrics; and
localizing, based on the discrepancies, one or more potential faults in at least one link, node, or device in the network.

3. The method of claim 1, further comprising
iterating over different Border Gateway Protocol (BGP) routing assignments for traffic flows in the network;
computing the predicted QoS metrics using the machine learning model; and
selecting an optimal routing assignment that satisfies one or more QoS constraints, wherein the constraints include at least one of delay, packet loss, or link utilization.

4. The method of claim 1, further comprising
iterating over potential network topologies during network planning;
computing, for each potential network topology, the predicted QoS metrics for traffic flows using the digital twin; and
selecting a candidate network topology that satisfies one or more performance constraints.

5. The method of claim 4, wherein the constraints include at least one of average network delay, packet loss thresholds, cost, or device count.

6. The method of claim 1, further comprising
iterating over one or more failure scenarios by removing or disabling at least one link or node in the digital twin;
predicting, for each failure scenario, the resulting QoS metrics using the machine learning model; and
identifying one or more critical nodes or links whose removal leads to a violation of at least one QoS constraint.

7. The method of claim 6, further comprising
flagging the identified critical nodes or links for priority maintenance, upgrade, or protection planning.

8. The method of claim 1, wherein the QoS metrics comprise one or more of: delay, packet loss, jitter, link utilization, or throughput.

9. The method of claim 1, wherein the machine learning model is a Graph Neural Network (GNN) trained on historical flow data to generalize QoS predictions across multiple topologies and traffic patterns without requiring per-scenario re-training.

10. The method of claim 1, wherein the traffic flow characteristics comprise at least any one or combination of a size of data packets, protocol type, bandwidth requirements, end-to-end latency requirements, or jitter constraints.

11. A non-transitory computer-readable medium comprising instructions that, when executed, cased one or more processors to perform steps of:
collecting network information including at least a topology of a network, traffic flow characteristics, and network performance data;
constructing a digital twin of the network based on the collected information, wherein the digital twin includes nodes, links, and associated traffic flows;
applying a machine learning model to the digital twin to predict Quality of Service (QoS) metrics for each traffic flow; and
outputting the predicted QoS metrics for further analysis or network actions.

12. The non-transitory computer-readable medium of claim 11, wherein the steps further include
comparing the predicted QoS metrics with corresponding QoS metrics measured from the network;
identifying one or more discrepancies between the predicted QoS metrics and the measured QoS metrics; and
localizing, based on the discrepancies, one or more potential faults in at least one link, node, or device in the network.

13. The non-transitory computer-readable medium of claim 11, wherein the steps further include
iterating over different Border Gateway Protocol (BGP) routing assignments for traffic flows in the network;
computing the predicted QoS metrics using the machine learning model; and
selecting an optimal routing assignment that satisfies one or more QoS constraints, wherein the constraints include at least one of delay, packet loss, or link utilization.

14. The non-transitory computer-readable medium of claim 11, wherein the steps further include
iterating over potential network topologies during network planning;
computing, for each potential network topology, the predicted QoS metrics for traffic flows using the digital twin; and
selecting a candidate network topology that satisfies one or more performance constraints.

15. The non-transitory computer-readable medium of claim 14, wherein the constraints include at least one of average network delay, packet loss thresholds, cost, or device count.

16. The non-transitory computer-readable medium of claim 11, wherein the steps further include
iterating over one or more failure scenarios by removing or disabling at least one link or node in the digital twin;
predicting, for each failure scenario, the resulting QoS metrics using the machine learning model; and
identifying one or more critical nodes or links whose removal leads to a violation of at least one QoS constraint.

17. The non-transitory computer-readable medium of claim 16, wherein the steps further include
flagging the identified critical nodes or links for priority maintenance, upgrade, or protection planning.

18. The non-transitory computer-readable medium of claim 11, wherein the QoS metrics comprise one or more of: delay, packet loss, jitter, link utilization, or throughput.

19. The non-transitory computer-readable medium of claim 11, wherein the machine learning model is a Graph Neural Network (GNN) trained on historical flow data to generalize QoS predictions across multiple topologies and traffic patterns without requiring per-scenario re-training.

20. The non-transitory computer-readable medium of claim 11, wherein the traffic flow characteristics comprise at least any one or combination of a size of data packets, protocol type, bandwidth requirements, end-to-end latency requirements, or jitter constraints.
